(19) United States
(12) Patent Application Publication
(10) Pub. No.: US 2019/0193208 A1
(43) Pub. Date: Jun. 27, 2019

(54) FEMTOSECOND LASER INSCRIPTION

(71) Applicant: CYPRUS UNIVERSITY OF TECHNOLOGY, Limassol (CY)

(72) Inventor: Kyriacos KALLI, Nicosia (CY)

(21) Appl. No.: 16/328,762

(22) PCT Filed: Sep. 3, 2017
(86) PCT No.: PCT/IL2017/050982

§ 371 Date: Feb. 27, 2019

Related U.S. Application Data
(60) Provisional application No. 62/382,788, filed on Sep. 2, 2016.
(60) Provisional application No. 62/463,899, filed on Feb. 27, 2017.

(51) Int. Cl. B23K 26/53; B23K 26/00; B23K 26/06; B23K 26/0622; B23K 26/08; B23K 26/352; B23K 26/082

(52) U.S. Cl. CPC B23K 26/53; B23K 26/0006; B23K 26/0608; B23K 26/0624; B23K 2103/54; B23K 26/0648; B23K 26/0823; B23K 26/355; B23K 26/082; B23K 26/0626

(57) ABSTRACT

The present invention relates to a novel method and system for inscription of periodic patterns inside or on a surface of a substrate using femtosecond pulse lasers. The method comprises the following steps: (a) receiving a plurality of femtosecond laser pulsed beams, each beam having a certain pulse duration, flux, focal spot size, profile and energy at a certain wavelength of operation; (b) controlling at least one of the pulse duration, flux, focal spot size, focal spot shape, profile and energy of the plurality of laser pulsed beams; (c) directing the plurality of laser pulsed beams onto a certain region of a substrate having an optical axis, to thereby selectively induce at least one of local index change, microvoids and stress-modulated region at a point of interaction between each beam and the certain region; (d) controllably displacing the substrate along its optical axis to create the periodic patterns on a first plane of inscription along the optical axis; and (e) creating spaced-apart planes across the substrate having a controlled index profile.

### TECHNOLOGICAL FIELD

The present invention relates to optics and photonics. In particular, the present invention relates to methods and systems for fabricating waveguides, gratings and integrated optical circuits.

### BACKGROUND

The fabrication of many photonic devices has been achieved through exposure of transmissive and absorbing materials to intense laser radiation in order to change the optical properties of said materials. For example, UV-induced photosensitivity of germanium doped silica glasses has been exploited in order to create permanent refractive index changes in the photosensitive Ge-doped silica cores of single mode optical fibers and waveguides as opposed to undoped cladding. By creating a spatial intensity modulation of the UV exposure either by using a two-beam interference technique as disclosed in U.S. Pat. No. 4,807,950 by Glenn et al. or by using a phase mask as disclosed in U.S. Pat. No. 5,367,588 by Hill et al., Bragg grating structures can be produced in the photosensitive core of the waveguide.

As disclosed by Glenn et al., permanent periodic gratings are provided or impressed into the core of an optical fiber by exposing the core through the cladding to the interference fringe pattern generated by two coherent beams of ultraviolet laser light that are directed against the optical fiber symmetrically to a plane normal to the fiber axis. The material in the fiber core is exposed to the resultant interference fringe intensity pattern created by the two overlapping UV beams creating permanent periodic variations in the refractive index along the length of the UV photosensitive core of the waveguide. The resultant index variations are oriented normal to the waveguide axis so as to form a Bragg grating.

A more popular method of photo imprinting Bragg gratings is taught by Hill et al. in U.S. Pat. No. 5,367,588 where an interference fringe pattern is generated by impinging a single UV light beam onto a transmissive diffractive optic known as a phase mask. The waveguide to be processed is placed immediately behind the phase mask and is exposed to the generated interference fringe pattern leading to the formation of the Bragg grating structure. In these examples, optical fibers or waveguides having a Ge-doped photosensitive core are irradiated with UV light at a predetermined intensity and for a predetermined duration of time sufficient to obtain a substantially permanent Bragg grating structure within the core of said waveguide.

These gratings provide a useful function, however they suffer from some limitations in terms of the amount of induced index change that is possible. In order for some Bragg grating structures to be written in a standard telecommunications single mode optical fiber, the optical fiber often needs to be photosensitized to UV light by exposing such an optical fiber to hydrogen or deuterium gas at elevated pressures and temperatures as taught by Atkins et al. in U.S. Pat. No. 5,287,427 or by hydrogen flame brushing as taught be Bilodeau et al. in U.S. Pat. No. 5,495,548. After exposure, the UV written structures need to be annealed at elevated temperatures in order to remove any remaining interstitial hydrogen or deuterium present in the waveguide core. As taught by Erdogan et al. in U.S. Pat. No. 5,620,496, this annealing step is often implemented in order to stabilize, by accelerated aging, the induced index change. These extra processing steps to the optical fiber or waveguide complicate the manufacturing of photonic devices and reduce yield.

Another method for creating permanent photoretractive index changes in glasses employs the use of intense UV beams with fluences or energy/unit-area per laser pulse densities that approach those required to produce macroscopic damage of the glass. Askins et al. in U.S. Pat. No. 5,400,422 teach a method for producing permanent photoretractive index changes in the photosensitive cores of Ge-doped optical fibers with single high intensity UV laser pulses. The high intensity portions of the interference fringes created by two crossed UV beams split from a single UV beam create localized damage at the core-cladding interface within the fiber. Because the process for inducing index change is one of structural change due to localized physical damage to the glass, rather than due to UV photo-induced color center formation, the induced index change is more robust and does not decrease with elevated temperature. Thus, annealing steps as taught by Erdogan et al. in U.S. Pat. No. 5,620,496 are not required. In fact Askins et al. disclose that gratings produced in this way cannot be removed by annealing until the fiber or waveguide approaches the material's glass transition temperature. The drawback of this approach for induction of index change is that the Bragg gratings produced in this fashion have relatively low refractive index modulations and are mechanically weak since the effective refractive index change results from periodic localized damage at the core-cladding interface. Since the damage mechanism is based on an intensity threshold process, the spectral quality of the resulting Bragg grating is often poor.

Recently processes that employ high-intensity laser pulses in the femtosecond pulse duration regime for creating permanent changes in the refractive indices of glasses have been explored by several groups of researchers. K. M. Davis et al. disclose a technique for inducing index change in bulk glasses with ultra-high peak power femtosecond infra-red radiation in Opt. Lett 21, 1729 (1996). The creation of waveguides in bulk glasses using this technique is taught by Miura et al. in U.S. Pat. No. 5.978,538 while the modification or trimming of existing waveguide structures is taught by Dugan et al. in US #20030035640. The physical process that appears to cause the refractive index change in the materials is due to the creation of free electrons through non-linear absorption and multi-photon ionization of hound charges, followed by avalanche ionization and localized dielectric breakdown as these free electrons are accelerated by the intense but short time duration laser field. Also, this leads to a localized melting and restructuring of the material and a concurrent increase in the index of refraction. Work performed in this field has used laser pulses that are tightly focused to near-diffraction limited spot sizes generating extremely high intensities of light, in order to initiate non-linear absorption processes in the materials. While this allows for high-resolution spatial localization of the refractive index change, it involves point-by-point scanning of the ultra-short-time-duration laser along the length and optical axis of the optical fiber or waveguide as disclosed by Fertein et al. Appl. Opt. 40 (21), 3506 (2001). This is a great disadvantage for writing retroreflectivc Bragg grating structures but is suitable for writing long-period Bragg grating structures which, instead of coupling light from the forward-propagating guided mode into a retro-reflecting guided mode, couple light energy traveling along the fiber in a forward-propagating guided mode into light that propagates into forward-propagating cladding modes where the light is at least partially attenuated. There are several examples of long-period grating fabrication. The point-by-point writing method is taught by Hill et al. in U.S. Pat. No. 5,104,209 using a slit-amplitude mask. A variation on the amplitude mask technique is taught by Tam in U.S. Pat. No. 6,208,787 where a plano-convex array of cylindrical microlenses is used to focus portions of an incident UV beam onto an optical fiber. Another technique for fabrication of long-period fiber gratings with an electric arc is taught by Kosinski et al. in U.S. Pat. No. 6,050,109.

In order to photo imprint retroreflective Bragg structures into the core of optical fibers or waveguides using high-intensity femtosecond time duration radiation, it is advantageous to generate an interference fringe pattern originating from a single femtosecond laser pulse using either a holographic technique, or a diffractive optic. Kawamura et al. in Appl. Phys. Lett. 78 (8), 1038 (2001) disclose an apparatus for producing a hologram using a two-beam laser interference exposure process, comprising the steps of using a femtosecond laser having a pulse width of 10 to 900 femtoseconds that is capable of generating a pulse beam at or close to the Fourier transform limit. The beam from the laser is divided into two beams using a beam splitter, controlled temporally through an optical delay circuit and spatially using plane and concave mirrors each having a slightly rotatable reflection surface to converge the beams on a surface of or within a substrate for recording a hologram at an energy density of 100 GW/cm2 or more with keeping each polarization plane of the two beams in parallel so as to match the converged spot of the two beams temporally and spatially, whereby a hologram is recorded irreversibly on the substrate formed of a transparent material, semiconductor material or metallic material. The volume hologram is optionally layered so as to provide a multiplex hologram recording that is permanent unless it is heated to a temperature to cause a structural change in the atomic arrangement of the substrate in which the hologram is inscribed. The authors teach this method in US Pat. Appl. 20020126333.

Maznev et al. Opt. Lett. 23 (17), 1378 (1998) disclose a technique for generating interference fringes with femtosecond pulses by overlapping two femtosecond beams that originate from a single beam which passes through a diffractive optical element. This method is taught by the authors in U.S. Pat. No. 6,204,926. Miller et al., in U.S. Pat. No. 6,297,894, teach a similar method for utilizing a diffractive optic to generate an interference fringe pattern in order to induce refractive index changes in materials using femtosecond time duration laser radiation. An exemplary embodiment of the invention of Miller et al. comprises a femtosecond laser source for providing light to a diffractive optical element. Light propagating from the diffractive optical element is incident on a curved mirror, which acts to focus the light into a lens or another curved mirror and then into a target.

However, it should be understood that the above-mentioned methods to inscribe grating structures using short pulse lasers are limited to point-by-point or line-by-line inscription. In both cases there exist several limitations that cannot be readily compensated. For example, these methods require that the gratings should be located precisely on the optical axis (in the case of an optical fiber) and that the laser beam should be aligned precisely onto the optical axis of the fiber. Moreover, in the point-by-point technique, the index changes cannot be precisely controlled.

Silica fiber Bragg grating (FBG) sensors are widely used as point sensors in a variety of applications from the measurement of strain and temperature to more complicated quasi-distributed sensing, such as for vibration mode shape monitoring, ultrasonic detection, and structural health monitoring that typically require arrays of gratings. Moreover, the single mode characteristics of standard fibers are well understood and avoid a number of problems that would otherwise be encountered with multi-mode optical fiber sensors, such as multiple peak spectra, overlapping modes and mode mixing. The evolution of polymer optical fibers (POFs) as an alternative to glass fibers has been complicated principally by the extremely high loss that is encountered in the near infra-red, often exceeding 100 dB/m, and by the lack of access to commercial single mode polymer fibers. This is unfortunate, as POF promises exceptional optical sensing capabilities if the two aforementioned disadvantages can be overcome. Optical sensors based on POFs could prove to be especially useful for medical applications, where insertion of plastic-based catheters is acceptable with regard to safety, and where physical, chemical and bio-sensors could be used to measure temperature, pressure, glucose levels, and antibody biomolecules. Moreover, the extremely low Young's modulus of POF, which is 25 times lower than that of silica, has the potential to offer very large strain ranges and wavelength tuning of FBG up to 5% strain, and POF is also temperature tunable. All currently commercialized polymer fibers are available only as multimode fibers, either step or gradient index fibers, driven by fiber to home (FTTH) applications where their larger fiber core diameter allows for easy and efficient coupling using low-cost connectors and sockets. The inscription of fiber Bragg gratings in multimode fibers results in the excitation of a large number of higher order modes producing a multi-peak FBG spectrum. This effect is acceptable for some applications where a low-resolution measurement can be tolerated. However, the occurrence of random mode mixing causes problems for conventional optical fiber sensor demodulation equipment, as peak tracking algorithms can no longer know which peak to track, and this issue is exacerbated if more than one multi-mode FBG is present.

### GENERAL DESCRIPTION

The technique of present invention provides a direct writing femtosecond laser fabrication process and system for devices having periodic refractive index modulation structures, with linear and arbitrary index profiles, for example, a 1 D Bragg grating, in its simplest form that can act as an optical filter and/or sensor.

As described above, conventional methods to inscribe periodic structures using short pulse lasers are limited to point-by-point or line-by-line inscription. This may be acceptable for use with single-mode optical fibers, hut is problematic for use with fibers having few mode or multi-mode spatial modes, as modal excitation is without control. These methods impose alignment requirements. Phase mask or interferometry systems have also been proposed to fabricate planes. However, these planes cannot be individually inscribed, nor can they be inscribed into the core only, or into the cladding by a user selectable amount. Moreover, these methods cannot readily control the scale of the inscription.

There is provided a novel method and system for inscription (i.e. direct writing) of periodic patterns (e.g. grating structures) inside (i.e. embedded) or on a surface of a substrate using short (femtosecond) pulse lasers. The material is thus modified by increasing or decreasing a local refractive index at the point of interaction between the laser beam and the optical media such as optical fibers and waveguides. Therefore, the invention is particularly useful for creating optical waveguides (core with cladding, core only, cladding only), Bragg gratings, etc. The waveguide can be inscribed by using the technique of the present invention and then either during the waveguide inscription process the grating is written, or the waveguide is inscribed, or the grating is written into the inscribed waveguide. By inscribing waveguides into the cladding and gratings sensors therein that are asymmetric, responsive to bend, also external refractive index changes can be fabricated.

Therefore there is provided a method for inscription of periodic patterns comprising the following steps: (a) receiving a plurality of femtosecond laser pulsed beams, each beam having a certain pulse duration, flux, focal spot size, profile and energy at a certain wavelength of operation; (b) controlling at least one of the pulse duration, flux, focal spot size, focal spot shape, profile and energy of the plurality of laser pulsed beams; (c) directing the plurality of laser pulsed beams onto a certain region of a substrate having an optical axis to thereby selectively induce at least one of local index change, microvoids and stress-modulated region at a point of interaction between each beam and the certain region; (d) controllably displacing the substrate along its optical axis to create periodic patterns on a first plane of inscription along the optical axis; and (e) creating spaced-apart planes across the substrate having controlled index profile at least in two dimensions. When the substrate comprises an optical fiber, the certain region of the substrate comprises at least one of core only, cladding only, or core with cladding.

In some embodiments, step (b) comprises at least one of spatially modulating the laser pulsed beam, scanning the laser beam transversely across the substrate, perpendicularly to the optical axis, and creating at least one of a local index change, microvoids and stress-induced region at a boundary between two different materials in the substrate. The spatially modulating of the laser pulsed beam may comprise at least one of scaling the beam by using optical arrangement and shaping the beam by using a spatial beam shaper. The scanning may be repeated on the same region to thereby control a level of refractive index change. Spatially modulating the laser pulsed beam may comprise using at least one of a spatial light modulator, an optical arrangement with a variable focus, and an arrangement of focusing lenses.

In some embodiments, the method comprises irradiating the certain region wherein the irradiation is performed at a controlled speed of inscription.

In some embodiments, the method comprises varying the speed of inscription independently for each plane of inscription to thereby modify the index profile and/or create a grating profile and/or produce higher order gratings. The plane of inscription may comprise a plane embedded inside the substrate.

In some embodiments, the method further comprises controllably displacing the substrate across its optical axis to create the periodic patterns on another plane of inscription spaced part from the first plane of inscription wherein the steps (a)-(e) are repeated at a certain period, wherein each grating plane is created individually, to thereby generate a grating structure. The controllable displacing of the substrate across its optical axis may comprise controlling a line spacing between spaced-art planes with a linear or non-linear increment.

In some embodiments, step (b) comprises controlling at least one of width, depth and length of the periodic patterns across the substrate for each plane individually to thereby control a shape of a 3D index profile.

In some embodiments, the method comprises creating non-symmetric planes in depth and width to create local birefringence.

In some embodiments, the method further comprises controlling a wavelength range of the femtosecond laser pulsed beams.

In some embodiments, the method further comprises rotating the substrate at a certain angle relative to an optical axis of the substrate prior to the plane inscription to thereby control an angle of a plane of inscription relative to the optical axis creating tilted gratings.

In some embodiments, step (e) comprises controlling a length of the plane, thereby controlling the strength of reflection from each of the planes.

In some embodiments, step (b) comprises varying the energy prior to inscription of each plane to control a birefringence of each plane and/or to control loss at the location of each plane.

The technique of the present invention enables reducing the alignment requirements and does not require that the gratings should be located precisely on the optical axis. Therefore, a rapid array of gratings may be fabricated in fibers or planar samples without complicated alignment procedures and the need for direct laser control, such as the need for a Position Synchronized Output (PSO) that links the stage position with the laser trigger on each axis of the motion control module, unlike conventional methods. The PSO ensures that the laser generates a pulse at a certain position and for these to occur simultaneously. Moreover, the technique enables the inscription of grating planes over the whole of the core region, whether the core material is doped or not.

The period of the inscription can be selected by the user to any desired value. Moreover, this technique enables to add chirp, and/or add/remove planes selectively. This technique creates each grating plane individually (i.e. 1 to 3D refractive index change, user selectable, controlled planes' dimensions). The profile shape of the index change can be also selected in three dimensions. The device dimensions are controlled by scanning the laser transversely across the core. The length of the grating is based on the number of planes which are selected to be inscribed. It should be noted that the profile shape determines the number of order gratings. Moreover, any wavelength of operation, either for first order or higher order gratings, may be selected. It should be also noted that the grating wavelength is selected by knowing the refractive index of the fiber at all wavelengths.

For example, this allows for the inscription of phase shifted gratings, as chirped gratings having user selectable time delay properties. This allows also the simple inscription of cavities, with or without chirp, sampled gratings, tilted gratings, and higher order versions thereof. Moreover, one can inscribe gratings for signal encoding and decoding, and gratings with plane sequences that are based on Fibonacci series, the Lucas number, recurrence relations and integer sequences or any other random sequence form. The control of local refractive index change (in doped and undoped fibers) and loss leads to the creation of components having gain/loss properties for the exploitation of parity-time symmetry. The generation of higher order gratings can he controlled so that a sequence of wavelength reflection occurs at predetermined wavelengths.

The inscription process of the device can be measured in real-time, on-line, using a typical grating measurement system, comprising of a tunable laser and detector system, or broadband light source and optical spectrum analyzer combination. The inscription can be modified “on-the-fly” until the desired spectral properties are achieved.

In some embodiments, the method also comprises controlling polarization properties of the gratings, by controlling an extent of the grating in width across the core and depth. For example, the grating plane can be made rectangular, as required by the user, inducing controlled birefringence.

In some embodiments, the method comprises controlling local birefringence by splitting a Bragg peak into two peaks. The level of local birefringence leads to a splitting of the measured grating peak, and this can be “split” into two guided polarization modes that can be separated using polarization selective elements.

In some embodiments, the method comprises controlling a birefringence of the grating, overall and for each plane. This can be performed by changing (increasing or decreasing) the laser energy prior to the inscription of each plane, which increases or reduces birefringence. Moreover local birefringence can be induced by making planes that are not symmetrical in depth and width. For example, a grating may be inscribed in a multimode fiber type, such that all or individual planes have the same or different dimensions, respectively, thereby exciting and interacting with different spatial core modes.

In some embodiments, the method also comprises controlling cladding mode coupling by controlling the extent of the grating. For example, control of the length of the plane across the core into the cladding, controls the relative strength of the core and cladding mode strengths. This holds for all grating types. If a tilted fiber Bragg grating is considered, the strength of cladding modes decreases as the plane extends into the cladding, conversely increasing as the plane is restricted to the core region.

In some embodiments, the method also comprises controlling the extent of the grating in the depth, width and length of the grating planes, allowing for 2D or 3D gratings. Each grating plane can have a different 2D and 3D profile, producing a custom grating type.

In some embodiments, the method comprises controlling transmission notch, reflectivity, device loss, index strength and device length, and also stopping the inscription process as the desired specifications are reached. It should be noted, that, as known to anyone skilled in the art, high reflectivity implies low transmission. The greater the index change, the more laser energy should be generated, and the greater the reflectivity and better band stop filter response. However, overly increasing the laser energy also increases local loss. In particular, the method comprises controlling loss at the location of each plane. This can be performed by changing (increasing or decreasing) the laser energy prior to the inscription of each line, increasing or reducing loss locally. The proposed novel laser inscription process is one of controlled loss, and this can be increased or minimized by changing (increasing or decreasing) laser energy and fluence during plane inscription. Fluence is calculated based on laser repetition rate and speed of motion.

In some embodiments, the method comprises controlling grating order. Higher order gratings that span two octaves either uniformly, tilted or chirped, can be inscribed. This can be performed by controlling the shape of the refractive index profile of each plane, higher order grating reflections, e.g. multiples of the primary reflection frequency (a Fourier series) are induced. The more square the profile, the greater the number of higher orders.

In some embodiments, the method comprises controlling duty cycle of the grating structure. This can be performed by spacing the planes and their period in a uniform or arbitrary manner, and, based on the step made prior to inscription of the next plane, the grating duty cycle can be controlled.

In some embodiments, the method comprises inscribing single peak gratings in multimode fiber.

In some embodiments, the method comprises changing the line spacing with a motion control module (e.g. step) to control the reflection wavelength. The step may be uniform for a uniform grating, or with a linear or non-linear increment for various types of chirped and custom gratings.

In some embodiments, the method comprises generating a laser having an energy up to 100 nJ/pulse.

According to another broad aspect of the present invention, there is provided a system for inscription of periodic patterns on a substrate having an optical axis. The system comprises a first beam directing module for directing a plurality of laser pulsed beams onto a certain region of the substrate to thereby selectively induce a local index change, microvoids and/or stress-modulated region at a point of interaction between each beam and the certain region, creating a controlled index profile on a plane of inscription at least in two dimensions; a motion control module for displacing the substrate at least along its optical axis, a control unit being connected to the motion control module, and a laser for controlling at least one of pulse duration, flux, focus, profile and energy and a controlled speed of inscription to thereby provide an index profile on the plane of inscription at least in two dimensions.

In some embodiments, the system further comprises a beam shaping element for spatially modulating the laser pulsed beam, wherein the beam shaping element comprises at least one of an optical arrangement with a variable focus, an arrangement of focusing lenses, slit element, and spatial light modulator.

In some embodiments, the system further comprises a second beam directing module for directing the femtosecond pulsed laser beam towards the beam shaping element, wherein the beam directing module directs the femtosecond pulsed laser beam from the beam shaping element towards the certain region of the substrate.

In some embodiments, the system further comprises a laser for generating a plurality of femtosecond pulsed laser beams having a certain pulse duration, flux, focal size spot, profile and energy at a certain wavelength of operation.

In some embodiments, the control unit controls the wavelength range of operation of the laser.

In some embodiments, the motion control module is configured for rotating the substrate.

### BRIEF DESCRIPTION OF THE DRAWINGS

In order to better understand the subject matter that is disclosed herein and to exemplify how it may he carried out in practice, embodiments will now he described, by way of non-limiting example only, with reference to the accompanying drawings, in which:

FIG. 1 schematically represents a flow chart of the principal steps of the method of the present invention;

FIG. 2 schematically represents a block diagram of the main functional modules of the system of the present invention;

FIG. 3A shows a sample FBG spectra for different values of grating strengths (kL), tailored by controlling the laser pulse energy;

FIG. 3B shows a sample FBG spectra for different values of lengths;

FIG. 4A represents definitions relating to the refractive index;

FIGS. 4B-4C show relative index change contributions induced by the inscription process for AC and DC changes for 40 pulses/um (FIG. 4A) and 80 pulses/um (FIG. 4B);

FIG. 5 shows an index change as a function of a speed of inscription;

FIG. 6 shows a change in grating strength (kL) and effective refractive index with different speed of inscription for various levels of laser dosage;

FIG. 7 shows grating strengths versus pulse energy for the number of pulses/um;

FIG. 8 shows grating strength versus fluence for various pulse numbers/um;

FIG. 9 shows gradient of grating strength (kL) versus the pulse number/um;

FIGS. 10A-10B show a spectra of an example of a uniform grating (16^{th} order in this example) where each plane has been inscribed with multiple passes;

FIGS. 11A-11B show the effective mode index (neff) and modulated index (dneff) with the number of laser passes, respectively;

FIG. 12 shows a reflection spectrum of a l0nm chirped grating of 2000 lines being created by using the teachings of the present invention with a laser of an energy of 116 nJ and a repetition rate of 5 kHz;

FIG. 13 shows a transmission spectrum of the chirped FBG of FIG. 12;

FIG. 14 shows 4^{th} and 8^{th} order chirped FBGs made by using the teachings of the present invention;

FIG. 15 shows a FBG Fabry-Perot cavity reflection spectrum, wherein the FBG Fabry-Perot cavity has been created by using the technique of the present invention;

FIGS. 16A-16C are microscope images of FBGs inscribed in low loss multimode gradient index CYTOP fiber using the teachings of the present invention with planes having 30 μm (16A), 15 μm (16B) and 5 μm (16C) width, across the center of the core;

FIGS. 17A-17B show depth of a grating plane fabricated by using the teachings of the present invention with respect to laser repetition rate for a fixed pulse energy of about 56 nJ/pulse (FIG. 17A), and with respect to pulse energy for a fixed repetition rate of about 10 kHz (FIG. 17B);

FIG. 18 shows spectrum for a long FBG (10mm) fabricated by using the teachings of the present invention in multimode POF, with the spectrum recovered from both the short side (a few cm from the FBG position in the fibre), to the long side having traversed a physical fibre length in excess of 20 m;

FIGS. 19A-19C show spectra for a Sum and 300 plane grating (FIG. 19A), for a 5 um and 500 plane grating (FIG. 19B) and for a 5 um and 1000 plane grating (FIG. 19C);

FIGS. 20A-20F show different types of FBGs in multimode CYTOP polymer optical fibres fabricated by using the teachings of the present invention; FIG. 20A represents a spectra for a single peak FBG, FIG. 20B represents a spectra for a FBG having a minimised mode mixing, FIG. 20C represents a spectra for a FBG array, FIG. 20D represents a spectra for a chirped FBG, FIG. 20E represents a spectra for a sampled FBG and FIG. 20F represents a spectra for a FBG Fabry-Perot cavity;

FIG. 21A shows a picture of a titled FBG fabricated by using the teachings of the present invention;

FIG. 21B shows a spectra showing cladding modes of the FBG of FIG. 21A;

FIGS. 22A-22C show spectra for higher order tilted FBGs showing the generation of cladding modes at multiple spectral locations, simultaneously, for sensing liquids and gases, according to the cladding mode wavelength position; and

FIG. 23 shows a spectrum for a FBG created in silicon core optical fibre, using the inscription process of the present invention.

### DETAILED DESCRIPTION OF EMBODIMENTS

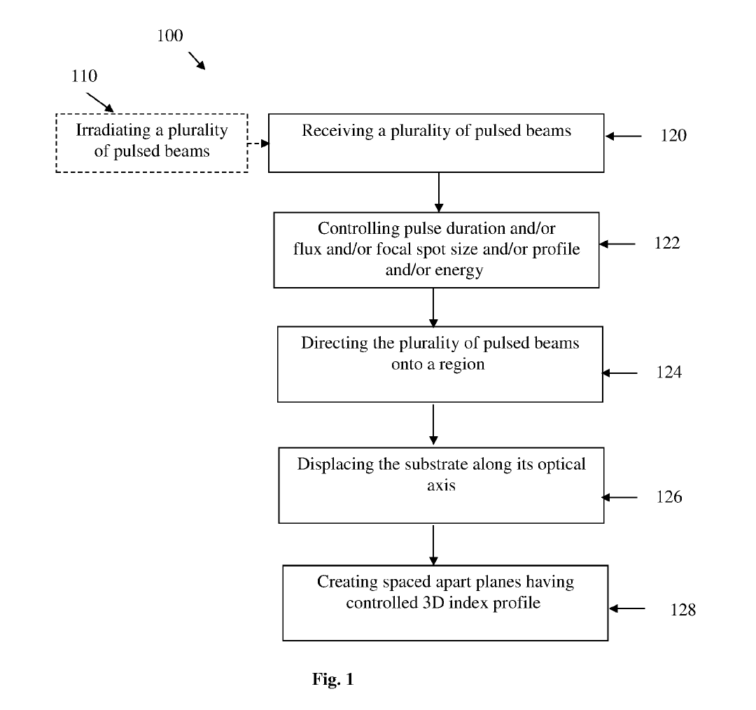

Reference is made to FIG. 1 showing, by way of a flow chart, principal steps of the method 100 for inscription of periodic patterns of the present invention. The method 100 comprises step 120 of receiving a plurality of femtosecond laser pulsed beams, each beam having a certain pulse duration, flux, focal spot size, beam profile and energy at a certain wavelength of operation; step 122 of controlling at least one of the pulse duration, flux, focal spot size, focal spot shape, profile and energy of the plurality of laser pulsed beams; step 124 of directing the plurality of laser pulsed beams onto a certain region of a substrate having an optical axis to thereby selectively induce at least one of local index change, microvoids and stress-modulated region at a point of interaction between each beam and the certain region depending on the laser characteristics; step 126 of controllably displacing the substrate along its optical axis to create the periodic patterns on a first plane of inscription along the optical axis; and step 128 of creating spaced-apart planes across the substrate having controlled 3D index profile. Step 128 further comprises controllably displacing the substrate across its optical axis to create the periodic patterns on another plane of inscription spaced part from the first plane of inscription wherein the steps 120-126 are repeated at a certain period controlled by control unit 110. The period of the inscription can be selected by the user to any desirable value. Step 122 may comprise controlling at least one of width, depth and length of the periodic patterns across the substrate for each plane individually to thereby control a shape of the 3D index profile. Method 100 enables direct one-step fabrication and integration of periodic or modified periodic refractive-index modulation devices and allows for low-cost, multifunctional one-dimensional grating devices, and is readily extended to two-dimensional or three-dimensional optical circuit fabrication of simple and complex optical systems. In the case of optical fibers (e.g. gratings) this can be realized in the core alone, the core-cladding interface or in the cladding alone. It should be understood that when a grating structure is created, each grating plane is created individually. Method 100 results in an index change that is 3D, having controlled width, depth and length and selected angle.

In this connection it should be understood that if the material is transparent (negligible linear absorption) at the laser's operating wavelength, then the laser-material interaction is driven through multi-photon absorption at the point of laser focus, whereas an opaque material will be processed on a length scale that is limited to laser-induced perturbations that are confined to the laser's penetration depth in the material.

The fast laser pulses (for example, but not limited to <250 fs) mean that, even for moderate, average laser powers, one can produce extremely intense light, if suitably focused. In the case of an opaque semiconductor material such as, but not limited to, silicon, silicon optical fibers have been realized, whereby the silicon core is bound by a transparent silica glass cladding. Silicon will be almost completely opaque if the laser operates at wavelengths below 1,1microns and here absorption will occur at shallow depths of <1 μm into the material. Regardless, it should be noted that the novel inscription technique can still produce grating structures in opaque fibers. It should be noted that the lack of material transparency at the laser wavelength of operation leads to a dramatic increase in the material absorption coefficient. This has the effect of significantly increasing the temperature at the laser focus. For length scales comparable to the laser wavelength, temperatures can reach 10∧4/10∧5K at the focus. However, given the low laser repetition rate, the fs laser processing is “cold”; rapid heat dissipation to the surroundings results in re-solidification of molten material on a small spatial length scale. In some embodiments of the present invention, the laser beam is swept/scanned transversely across the substrate's optical axis (e.g. fiber's longitudinal axis), thereby creating planes across the core by modifying the silicon-glass interface, and leading to stress modulation across the core. When this process is repeated over a given period, a uniform grating structure is induced. The inventor has shown that femtosecond laser processing is a flexible approach for modifying semiconductor-core, glass clad fibers. By careful control of the laser focusing parameters, the inventors have shown that it is possible to induce controlled stress at the core cladding interface, and by doing so, create a periodic grating structure within the silicon with a readily measurable wavelength spectrum, even though there is practically no light penetration into the silicon at the short laser inscription wavelength. This FBG formation opens a route to fiber-based silicon Raman lasers. Fibers having these core materials could also be stressed directly by fs laser processing.

In some embodiments, method 100 comprises generating an infrared, visible, ultraviolet wavelength laser beam having femtosecond laser pulse, shaping the beam and controlling its pulse duration and intensity to optimize its modifying/treating materials, and directing the beam onto/into a sample to create an intensity sufficient (for example 10¹⁰ W/m²) to modify the material. Beam shaping allows for the use of diffracting and non-diffracting beams to induce the index change. The technique of the present invention may be adapted to any system generating pulsed beams and therefore the plurality of pulsed beams may be received by a laser external to the inscription system. Alternatively, the laser may be integrated to the inscription system of the present invention and in this case, method 100 comprises an optional step 110 of irradiating the certain region with a plurality of pulsed beams at a controlled speed of inscription.

Method 100 also comprises modifying a profile of any index trimming (e.g. direct apodization) and/or producing higher order (e.g. saturated) gratings by controlling the speed of inscription. In this connection, it should be understood that if the speed of inscription is slow down a larger index, change is induced, and conversely a speed increase induces a smaller index change, and in this way the index can be profiled.

Modification of the index profile can be implemented in the following possible ways:
1) By controlling the speed of inscription of each grating plane such that the speed is inversely proportional to the laser-induced index change, e.g. slower speeds give a stronger index change. In this way the grating profile is tailored for any apodization function.
2) By controlling the extent to which the lines run across the core, thereby controlling interaction between the grating planes and the propagating light mode; the longer the plane across the core, the greater the modal interaction, thereby controlling the strength of reflection from each of the grating planes. In this way the grating profile is tailored for any apodization function.
3) By controlling the line spacing across the grating, so that the lines at the end of the grating have different width to those at the center, thereby “smearing” reflectivity contributions from the ends. In this way, the grating profile is tailored for any apodization function.
4) By scanning each line more than once to control the level of refractive index change.

In some embodiments, step 122 of controlling of the laser pulsed beam comprises spatially modulating the laser pulsed beam and/or scanning the laser beam transversely across the substrate perpendicularly to the optical axis and/or when the substrate is made of two different materials creating at least one of a local index change, microvoids and stress-induced region at a boundary between the two different materials.

In some embodiments, method 100 comprises scanning the laser beam transversely across the core, perpendicular to the fibre axis and/or scaling the beam by using lenses and/or shaping the beam by using a spatial beam shaper and/or inducing changes in the core by using only the different non-linear threshold between the core (if doped) and cladding (undoped). For example, the damage threshold of Ge-doped silica glass (core material) is less than the damage threshold for pure silica fiber cladding. It should be understood that by scanning the laser beam transversely across the core, perpendicular to the fibre axis, the width of the grating plane can be controlled. By controlling i) the laser energy, or ii) the laser flux, or iii) the laser focus, or iv) the beam profile with an spatial beam shaper, the depth of the plane can he controlled. it should be noted that the refractive index change can be as small as 10⁻⁵ or as large as 10⁻¹. This can be performed by changing (increasing or decreasing) the laser energy prior to inscription of each line, increasing or reducing the index change for each line individually.

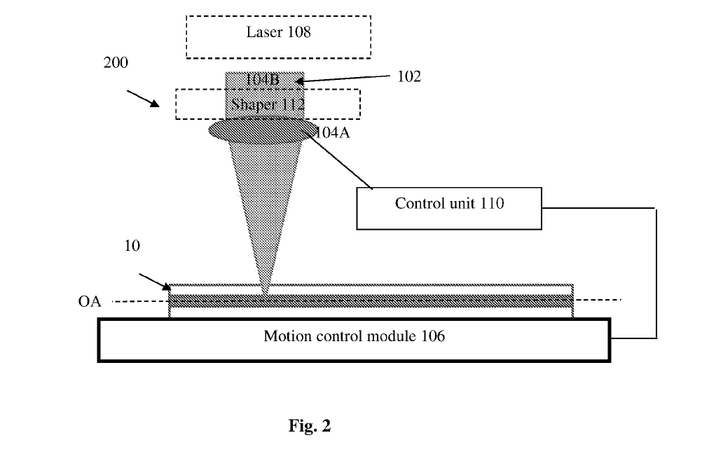

Referring to FIG. 2 there is illustrated, by way of a block diagram, a partial schematic view of a structural and functional part of an inscription system 200 for inscription of periodic patterns on a substrate 10 having an optical axis OA. The system 200 comprises a first beam directing module 104A for directing a plurality of laser pulsed beams 102 onto a certain region/target point of substrate 10 to thereby selectively induce a local index change, microvoids and/or stress-modulated region at a point of interaction between each beam and the certain region, creating a controlled 3D index profile on a plane of inscription, a motion control module 106 for carrying and displacing substrate 10 at least along its optical axis, and a control unit 110 being connected to motion control module 106 and a laser 108 for controlling at least one of pulse duration, flux, focus, profile and energy and a controlled speed of inscription, to thereby provide a 3D index profile on the plane of inscription. Laser 108 generates a plurality of beams having the characteristics of a femtosecond laser pulse and having the certain pulse duration, flux, focal size spot, profile and energy at a certain wavelength of operation. Laser 108 may be integrated in system 200 of inscription, or may be an external element connected and controlled by the control unit 110.

Control unit 110 is configured generally as a computing/electronic utility. Control unit 110 is connected to motion control module 106 and laser 108 by wires or wireless. The control unit 110 is configured and operable to control at least one of pulse duration, flux, focus, profile and energy and a controlled speed of inscription. Control unit 110 may also control wavelength range of operation of the laser. The wavelength range of the plurality of laser beam 102 may be modified to an infrared, visible or ultraviolet wavelength laser beam in order to treat materials that have suitable transparency required for the correct non-linear material treatment. The material should be transparent at the laser wavelength of operation, meaning minimal linear absorption.

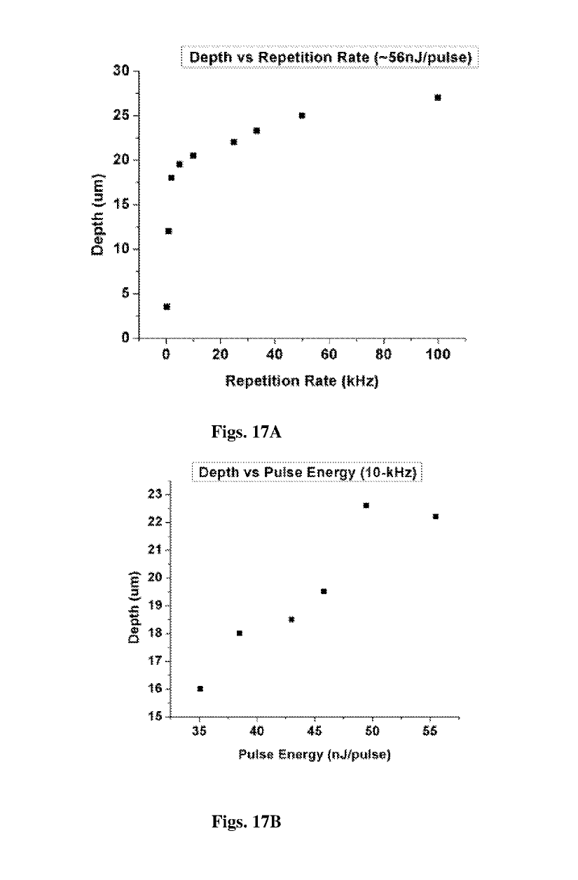

In some embodiments, substrate 10 comprises at least one of optical fibers (silicate based, silicon or other semi-conductor and polymer) and planar samples consisting of any material (transparent or otherwise at the laser inscription wavelength), thereby creating all possible fiber grating types, such as but not limited to, Bragg, long period, superstructure (sampled), phase-shifted, chirped (any profile , with direct control over the chirp rate) complex (random location of grating planes and amplitude strength), multiple order gratings, apodised and combinations thereof, such as, but not limited to, Fabry-Perot cavities (symmetric or asymmetric). In this connection, it should be noted that the technique of the present invention is applicable to all optical fiber types, such as microstructure, solid core, large core area, jacketed, and encapsulated optical fibers, which is not the case with conventional methods. For example, the substrate may be a core of optical single- or multi-mode fibers. The method may therefore inter alia inscribe simple and complex Bragg gratings applicable to all types of optical fibers. The Bragg gratings fabricated by using the novel technique of the present invention have tailored characteristics and compatibility with existing optical networks. In some embodiments in which the technique of the present invention is applied for fabricating Bragg gratings, the novel plane-by-plane technique, in which controlled 3D index changes are induced using a short pulse laser, inscribes each grating plane with a specific width, depth and length, whilst also maintaining control over the index change as will be illustrated below with respect to FIGS. 17A-17B.

In some embodiments, system 200 comprises a beam shaping element 112 for controlling beam characteristics and spatially modulating the laser pulsed beam, wherein beam shaping element 112 comprises at least one of a simple lens arrangement with a variable focus, an arrangement of focusing lenses, slit element, Spatial Light Modulator (SLM) to beam shape, so that individual planes can have tailored properties, generate diffracting and non-diffracting beams for inscription, such as Gaussian (and variations thereof), Bessel, Airy, Vortex . . . Moreover, it should also be noted that the process is nonlinear in nature and has a threshold. Spatial beam shaper 112 may thus also include a module configured for controlling the different nonlinear thresholds for the core and cladding materials. The stress induced at the boundary between two materials induces planes. Also, in this case, all planes are written individually and the complete customization of the grating is still possible. For example, increasing the laser energy modifies the shape of the focal spot from circular to elliptical, and a swept ellipse produces a plane. In this case, system 200 further comprises a second beam directing module 104B for directing the femtosecond pulsed laser beam 102 towards beam shaping element 112. First beam directing module 104A directs the femtosecond pulsed laser beam 102 from the beam shaping element 112 towards the certain region of the substrate. Second beam directing module 104B focuses a short pulsed laser beam onto a plane of the substrate (e.g. a plane inside the substrate) while the beam being focused passes through (generally, interacts) with spatial heam shaper 112 to thereby create controlled 3D index changes generating periodic refractive index modulation structures with linear and arbitrary index profiles on this plane.

In some embodiments, motion control module 106 is configured for rotating substrate 10 at a certain angle (user-defined) relative to optical axis OA of the substrate prior to the plane inscription, to thereby control an angle of a plane of inscription relative to the optical axis, creating tilted gratings. Planes having any angle, at any stage of the inscription process, and independently for any plane, can be fabricated.

In this way there is provided plane by plane directly writing of patterns (e.g. planes) having user defined width and depth across the substrate, enabling controlled coupling between the grating and waveguide modes, or planar waveguide, producing 2D and 3D grating structures, and having user selected angle or tilt relative to the optical axis of the waveguide. The angle of the grating planes relative to the optical axis of the fiber is thus controlled by the user, and can be any angle for these so-called tilted gratings.

In some embodiments, by focusing a femtosecond pulse laser beam onto an optically transparent material, such as a substrate or any type of optical fiber, a refractive index modulation can be induced that has both a net positive or negative index change, compared with unprocessed material, and which has a controlled spatial extent in three dimensions. The method provides a control of the degree of index change (positive or negative) and laser fluence.

Alternatively, the fiber may be opaque at the laser's operating wavelength. The technique writes a plane within the field by inducing a stress field within the opaque fiber that constitutes the grating.

As noted above, any wavelength of operation, either for first order, or higher order gratings, may be selected. It should be also noted that the grating wavelength is selected by knowing the refractive index of the fiber at all wavelengths.

The specific and non-limiting example below describes creation of a Bragg grating by using the teachings of the present invention. Silicon fibers were produced using a conventional draw tower, with a silica preform loaded with a silicon rod; the composite fiber was heated and drawn to form a coaxial silicon-silica fiber with a 125 μm outer diameter, and a 12 μm core. The fibers mounted on the system of the present invention comprised a motion control module e.g. Aerotech air hearing stages (ABL1000) for high-resolution, two-axis motion, and a control unit for precise synchronization of the laser pulse and stage motion allowed for suitable laser processing. Laser inscription was undertaken using a HighQ laser (femtoREGEN) operating at 517 nm, with 220-fs pulse duration, and a laser flux of about 10 J/cm². The side of the core was exposed to laser pulses of energy 100 nJ, at a repetition rate of 5 kHz, and for a focal spot size of about 1 μm, resulting in an energy density of about 10 J/cm², a value that can readily result in projected extreme temperatures at the laser focus. During the inscription process, strong plasma generation in the region of the Si core was observed as the laser beam was swept transversely across the core at a velocity of 50 μm/s, resulting in a mean exposure of 100 pulses/gm. The laser pulses introduced strain at the interface between the glass and the core without significantly affecting the properties of the core material. The fiber was displaced by a controlled step, and this motion was repeated to define a periodic modulation along the fiber length. This resulted in fabrication of a Bragg grating, which was probed in longitudinal reflection through the silicon core. Periodic modulation of the core region was repeated every about 1820 nm, corresponding to an 8th order grating; where it was determined that a silicon refractive index value of 3.4408 would result in a grating close to 1565 nm, as measured.

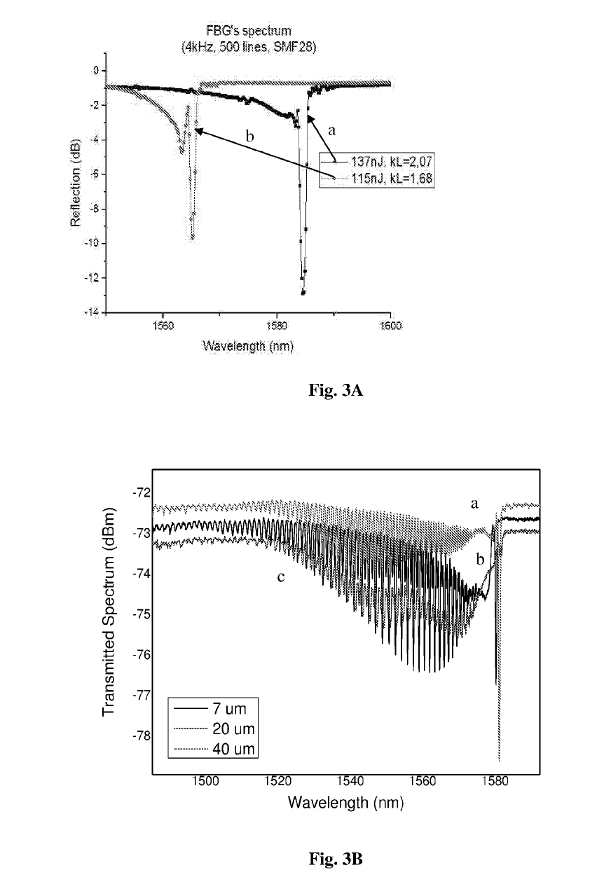

Reference is made to FIG. 3A, showing sample FBG spectra for different values of grating strength (kL), tailored by controlling the laser pulse energy. The sample was in this specific case an industry standard single mode optical fiber made first by Corning Glass (SMF28). Spectra a was obtained for a laser pulse energy of 137 nJ for a pulse duration of 220 fs, while spectra b was obtained for a laser pulse energy of 115 nJ. The period of inscription can be selected by the user to any desirable value. In the example below of FIGS. 3-10 it was selected to be 500 lines.

Reference is made to FIG. 3B, showing, for a sample, tilted FBGs in Fibercore PS1250/1500 for 7 degrees with a spacing of 2 mm difference in lines length running across the core. The tilted FBGs were fabricated by using the teachings of the present invention in which the length was controlled. Curve a represents the transmitted spectrum for the tilted FBG having a length of 7 μm being completely in the core. Curve b represents the transmitted spectrum for the tilted FBG having a length of 20 μm which means having 6 μm into the cladding on both sides of the core. Curve c represents the transmitted spectrum for the tilted FBG having a length of 40 μm which means having 16 μm into the cladding on either side of the core. It can be seen that the strength of cladding modes decreases as the plane extends into the cladding, and conversely increases as the plane is restricted to the core region. It is therefore demonstrated that the technique of the present invention is capable of inscribing into cladding, and how this affects strength of cladding modes in tilted FBGs. The control of extent of the grating therefore controls the cladding mode coupling, and the relative strength of the core and cladding mode strengths.

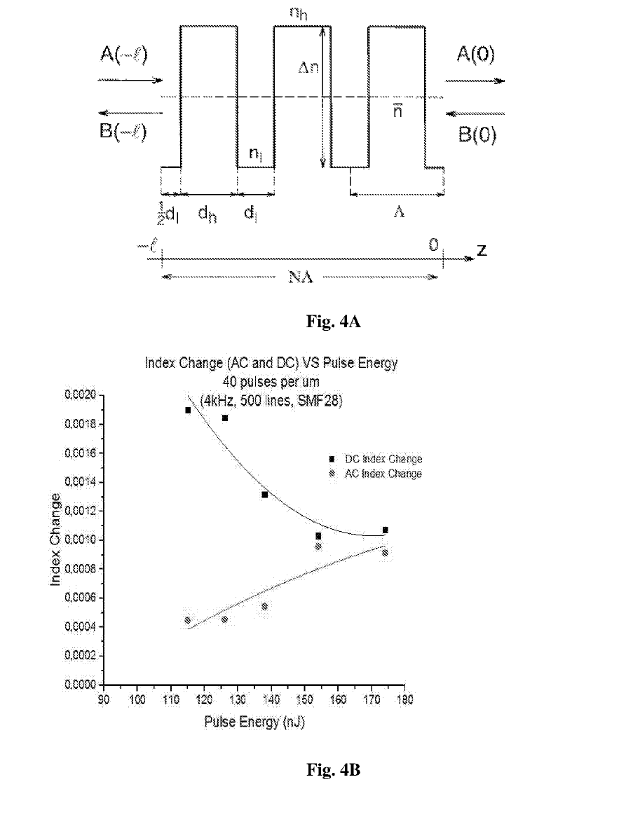

Reference is made to FIG. 4A, showing a rectangular shape index profile with an average refractive index as known by anyone skilled in the art. The average refractive index is nₐᵥ=½(nₕ+n₁) and an index difference is Δn=nₕ−−n₁. The period is given by: Λ=dₕ+d₁⇒ and the mean effective index is determined by:

$$Λ \cdot {n}_{eff} = {d}_{h} \cdot {n}_{h} + {d}_{l} \cdot {n}_{l}$$

$$Λ \cdot {n}_{eff} = {d}_{h} \cdot ( {n}_{l} + Δ n ) + {d}_{l} \cdot {n}_{l}$$

$${n}_{eff} = {n}_{l} + Δ n \cdot \frac{{d}_{h}}{{d}_{h} + {d}_{l}}$$

where n_{eff} is the effective index of the exposed fiber to the laser radiation and

Δn=nₕ−nₗ

Reference is made to FIGS. 4B-4C, showing the relative index change contributions induced by the inscription process for index difference (An represented as AC in the figure) and effective index (neff represented as DC in the figure) for 40 pulses/um (FIG. 4B) and 80 pulses/um (FIG. 4C). Therefore the inventor has shown that the core material is modified by increasing or decreasing a local refractive index at the point of interaction between the laser beam and the optical media, such as optical fibers and waveguides, by modifying the pulse energy.

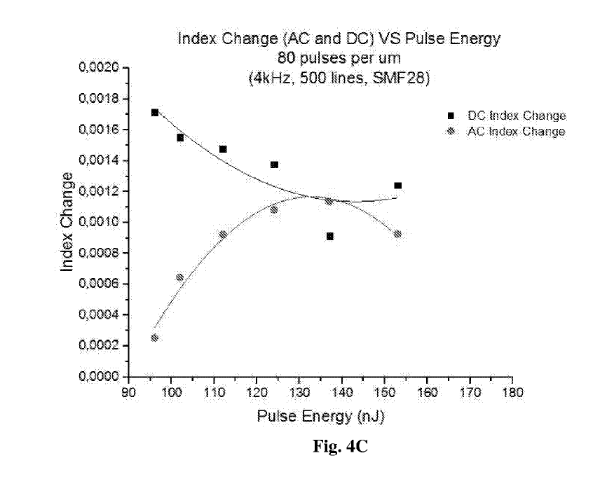

Reference is made to FIG. 5 showing an index change as a function of inscription translation speed.

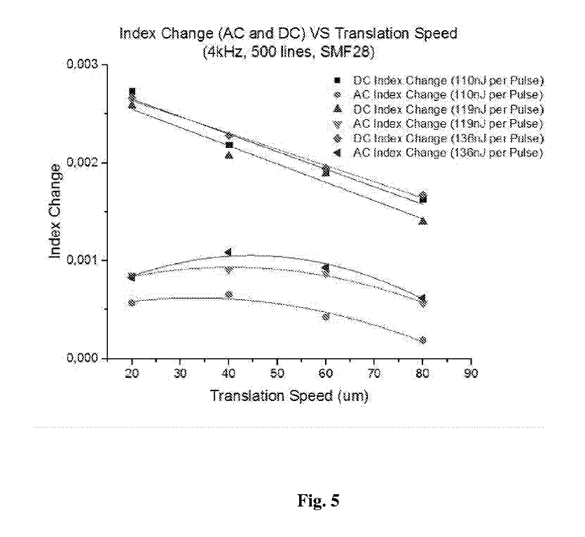

Reference is made to FIG. 6 showing a change in grating strength (kL) and effective refractive index do with translation speed for various levels of laser energy.

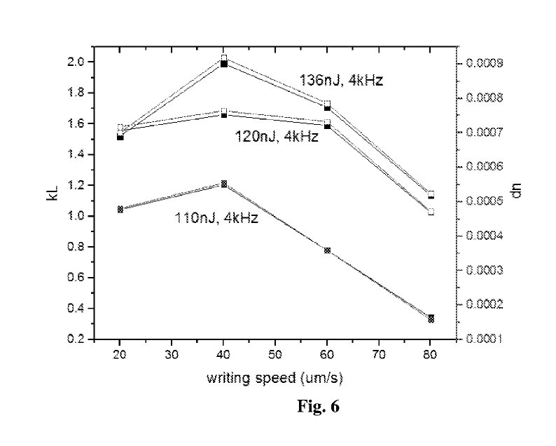

Reference is made to FIG. 7 showing grating strengths (kL) versus pulse energy for the number of pulses/um, showing that the “ideal” pulse number of 100 pulses/um indicates maximal index change peaks, for this particular fibre material.

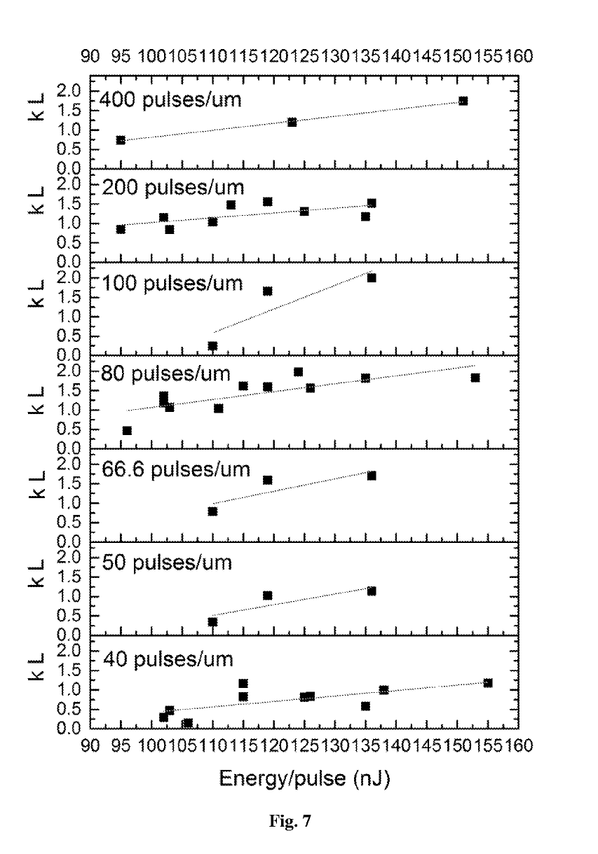

Reference is made to FIG. 8 showing grating strength versus fluence for various pulse numbers/um, confirming the ideal pulse number of 100 pulses/um.

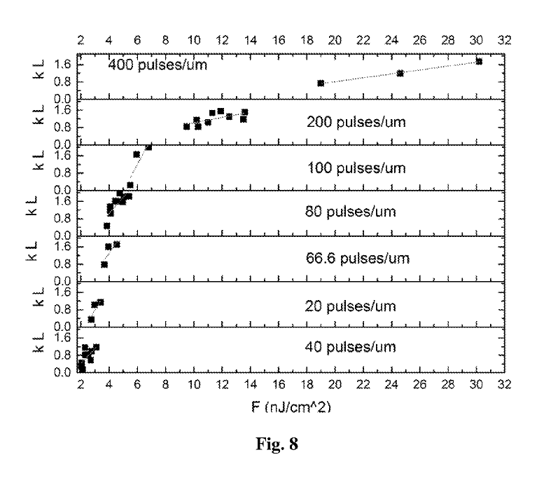

Reference is made to FIG. 9 showing gradient of grating strengths (kL) versus the pulse number/um, showing that 100 pulses/um is close to an ideal value.

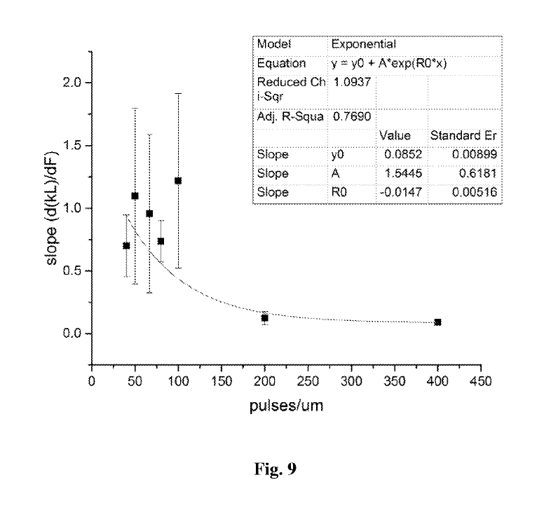

Reference is made to FIGS. 10A-10B showing an increase in grating strength, without significant increase in device loss, with number of overwritten passes for a 16^{th} order grating spectra (FIG. 10A) and reflectivity (FIG. 10B) from 37 to 65%. The number of passes refers to the number of times that the laser is swept back and forth over the same plane. For example, four passes means the laser was swept across the same plane four times, each time increasing the index change, until saturation is reached. These figures show how the index change can be controlled without the use of PSO, and how the process can saturate with multiple passes with a reflectivity of 37% for a single pass to 65% on the fourth pass. It should be noted that the centre wavelength of the grating has not significantly changed.

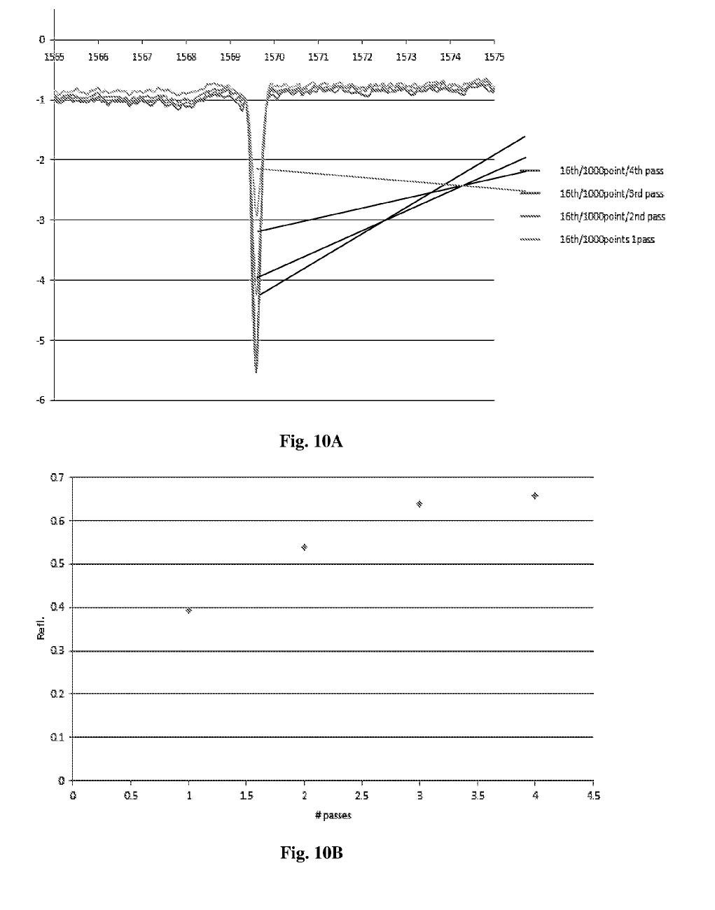

Reference is made to FIGS. 11A-11B showing mean index change (neff) and modulated index change (dneff) with pass number.

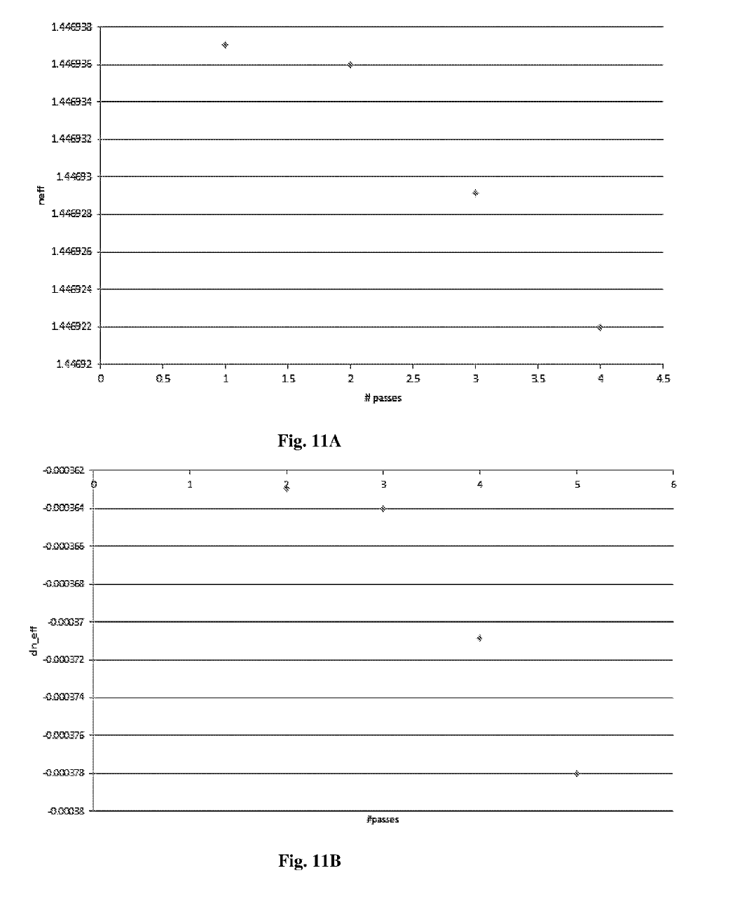

Reference is made to FIG. 12 showing a reflection spectrum of a 10 nm chirped grating of 2000 lines fabricated by using the technique of the present invention with a laser having a pulse energy of 116 nJ at a repetition rate of 5 kHz. The filter is centered at an operating wavelength of 1585 nm. Therefore it is shown that the technique of the present invention comprises controlling reflection depth TdB, by varying the wavelength of operation.

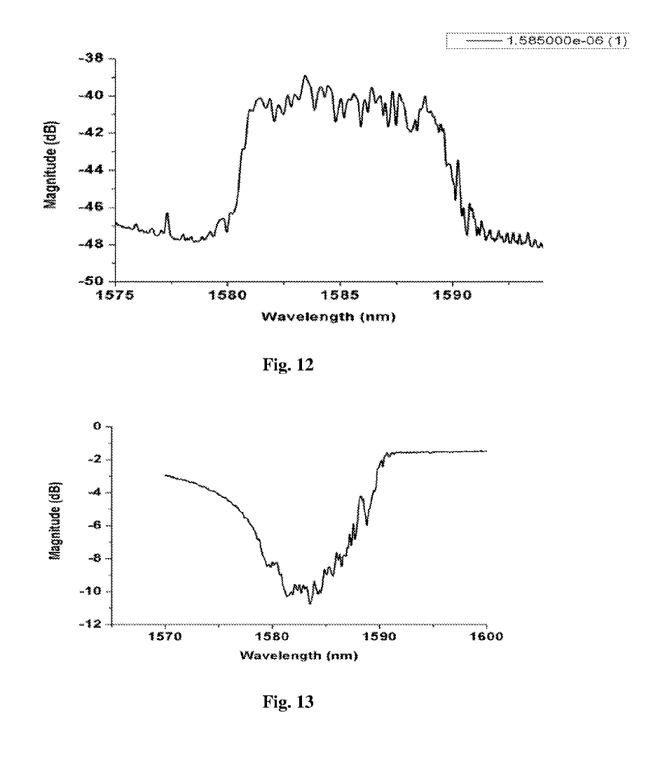

Reference is made to FIG. 13 showing a transmission spectrum of a 10 nm chirped grating of 2000 lines fabricated by using the technique of the present invention with a laser having a pulse energy of 116 nJ at a repetition rate of 5 kHz.Therefore it is shown that the technique of the present invention comprises controlling transmission depth TdB, by varying the wavelength of operation.

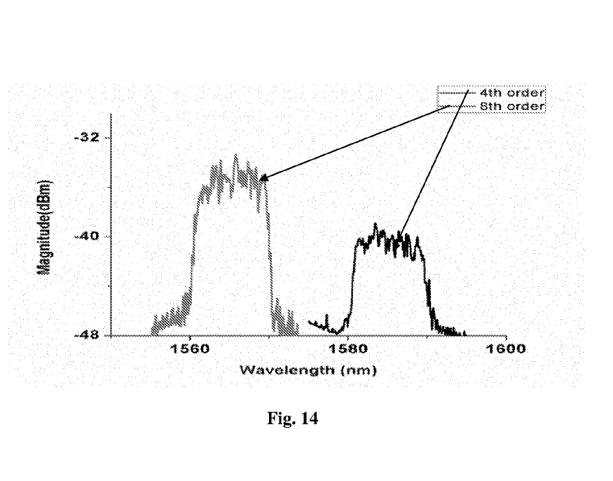

Reference is made to FIG. 14 showing 4^{th} and 8^{th} order chirped FBGs. The gratings were inscribed using the plane-by-plane novel method of the present invention, having linearly increasing line spacing, but with different spacing between the planes, with the 4^{th} order device having plane spacing half of the 8^{th} order device. In this specific and non-limiting example, the laser characteristics were selected as follows: energy about 110 nJ/pulse, repetition rate about 5 kHz and scan speed about 50 microns/sec.

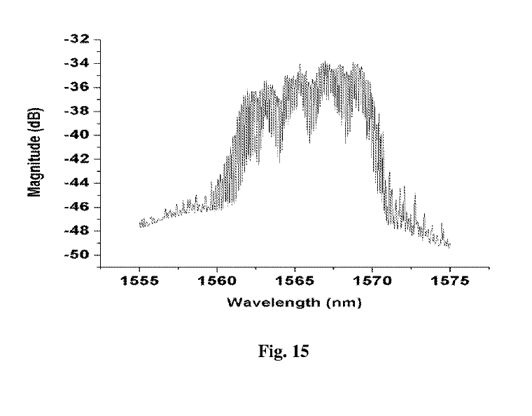

Reference is made to FIG. 15 showing a FBG Fabry-Perot cavity reflection spectrum. The laser characteristics were about the same as in the FIG. 14 above with a spacing of about 2 mm to create a cavity. Two gratings were inscribed with a fixed spacing between them of about 2 mm, thereby forming a cavity. The spacing is defined by the user and is not limited in value.

The specific and non-limiting example below describes creation of Fiber Bragg gratings (FBGs) and Fabry-Perot cavities in low-loss multimodc gradient index cyclized transparent optical polymer (CYTOP) polymer fiber by using the teachings of the present invention. The inscription laser system (HighQ laser femtoREGEN) operates at 517 nm, through second harmonic conversion of the fundamental operating wavelength using a crystal, producing pulses of 220 fs duration. Fibre motion was controlled using an Aerotech, 2-axes, motion control module. The laser beam was focused into the fibre using a long-working-distance microscope objective x50 (Mitutoyo) mounted on another stage. Based on this set-up, refractive index modifications are induced in the fibre without removing the outer jacket.

In order to find the correct inscription parameters for single peak FBGs, the gratings having a plane of 5, 15, and 30 μm widths centred in the middle of the core and total FBG lengths of either 660 μm or 1100 μm were inscribed by using the teachings of the present invention. To avoid overlapping index planes, 4th order gratings were inscribed by using the teachings of the present invention. The gratings were connected to a circulator using the butt coupling method and illuminated using a broadband light source (Thorlabs ASE730). Their reflected amplitude spectra were measured using a fast commercial spectrometer (IBSEN IMON) with about 169 pm optical resolution and integrated exposure time of 10 μs. The number of grating peaks is strongly dependent on the width of the inscribed planes and the length of the gratings. Longer gratings with wider planes have spectra with more peaks. The grating sample with Sum plane width and 660 μm length shows one single peak. Single peak with higher intensity was obtained for the grating with 15 μm plane width and 660 μm total length. The index change, δn was found about 5×10−4 with kL of about 0.5, where k is the coupling constant and L is the grating length.

Birefringence needs to be considered for sensing applications and communication systems, which could result from asymmetry of the fibre core, and any birefringence induced during the transverse inscription process. Using a linear polarizer between the source and the FBG samples, the input state of polarisation of the source was controlled, and the transmitted amplitude spectrum for different polarization angles was measured in the range 0°-360°. The maximum wavelength shifts attributed to the birefringence were 70 pm and 130 pm for 5 μm plane width, 115 pm and 140 pm for 15 μm plane width and 70 pm, and 320 pm for 30 μm plane width, for grating lengths of 660 μm and 1100 μm, respectively. Higher birefringence was obtained for longer grating length for the same plane width.

For the inscription of chirped FBGs (CFBGs), 15 μm width planes were chosen to ensure a strong backreflection, whilst also offering spectra similar to that with 5 μm width plane. The CFBG consisted of 2000 periods with a total length of about 4.5 mm.

The period of the grating was increased by steps of 7.65 pm for each plane, giving a period difference of ΔΛ=0.0153 μm. The initial period was about 2.3 μm for a 4^{th} order CFBG with a resonance wavelength centred at 1560 nm.

The Fabry-Perot (FP) cavity was made by inscribing two identical 4^{th} order FBGs with a grating length of about 660 μm and 15 μm planes width. The two FBGs were physically separated with a cavity length of 3 mm.

Therefore the teachings of the present invention were used to minimise coupling between the grating and the higher order propagation modes of the multimode CYTOP POF. Gratings with different plane widths and total grating lengths were inscribed, and gratings with wider plane width and longer length were found to have more peaks in the spectrum.

Moreover, as described above, the teachings of the present invention, where the beam is scanned transversely across the core to create 2D refractive index planes, may be used to limit excitation to the fundamental mode, and minimize multi-peak reflections and their coupling effects that are typically observed for Bragg gratings in multimode fibres, producing, instead, single peak spectra. The low-loss advantages of CYTOP were used together with the teachings of the present invention to address methods to control the multi-peak FBG reflection spectrum typical for highly multi-mode fibres. A femtosecond laser was used to inscribe individual grating planes transversely across the fibre core, resulting in a modified, 2D refractive index sheet, building the grating in a step-wise process, and, by so doing, have full control of the index change and grating length. In this way, the degree of coupling between the FBG and the higher order fibre modes was effectively selected and minimized. Excitation to the lowest order mode was limited. This plane-by-plane novel technique is readily suited to the production of multiplexed FBGs through control of the grating plane spacing and is used to inscribe an array of FBG sensors in CYTOP POF, operating between 1520-1590 nm. A gradient index CYTOP fibre with core diameter of 62.5 μm, a 20-μm cladding layer and a polyester and polycarbonate outer coating that offers fibre protection, was used. The inscription grating planes were inscribed in the centre of the fibre core, without removal of the protective outer coating, using a femtosecond laser system (HighQ Laser femtoREGEN). The laser operated at 517 nm, emitting 220 fs pulses at a 2-kHz repetition rate. The laser pulses at the exit had energies ˜80 nJ/pulse. A 2-axis air-bearing translation stage system moved the fibre relative to the laser beam that was focused from above using a long working distance microscope objective (×50, NA 0.42, Mitutoyo). The inscriptions were realised with plane widths of 5 μm, 15 μm and 30 μm, and their reflection spectra were recovered in each case for grating lengths corresponding to 300, 500 and 1000 planes, leading to a series of short and relatively strong gratings.

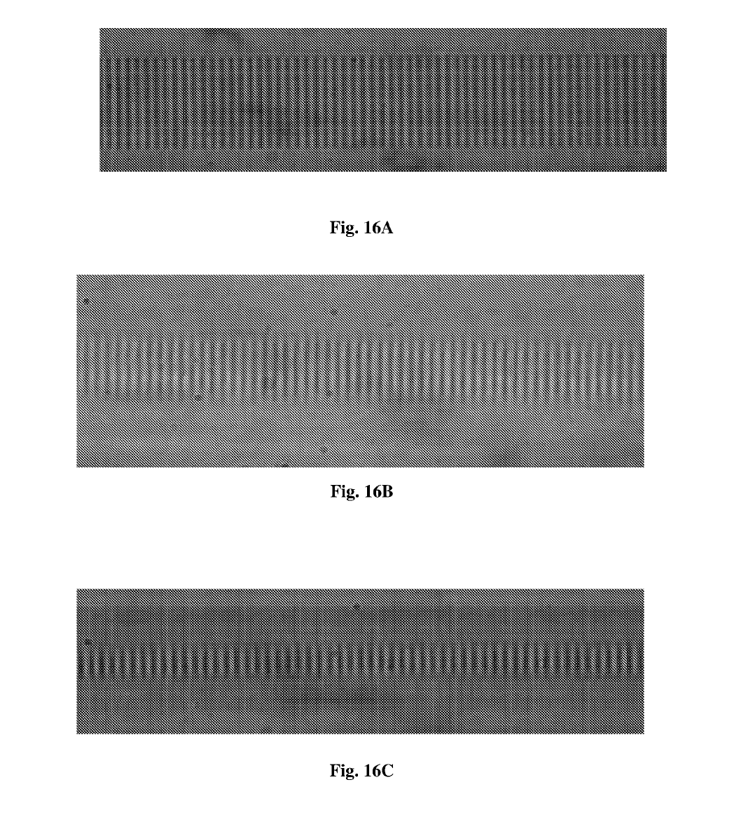

Reference is made to FIGS. 16A-16C representing microscope images of FBGs inscribed in low loss multimode gradient index CYTOP fibre using the novel inscription technique of the present invention with planes having 30 μm (FIG. 16A), 15 μm (FIG. 16B) and 5 μm (FIG. 16C) width, across the centre of the core. As the grating length increased, the gratings became stronger with reduced bandwidth, as anticipated. To compare the strength of the gratings in terms of recoverable reflectivity, all the gratings were interrogated with a commercial spectrometer (Ibsen I-MON 512, having 169.5 pm optical resolution) while keeping constant the capture integration time (10 μs). The multi-peak, grating reflection spectra, were observed to be strongly dependent on the width of the fs-laser inscribed planes and more so on the grating length. The gratings having longer length and wider planes were clearly more multimode. Comparing the reflection spectra, the gratings with the shorter length, 300-500 planes (grating length −0.65 1.1 mm), were found to exhibit significantly less mode excitation and the sample inscribed with 5 μm plane width showed a single peak reflection spectrum. To evaluate the correctness of the results, the reflection spectrum was measured for the 5 μm and 300 planes FBG with an optical spectrum analyser (Advantest Q8384) with high optical resolution (10 pm). Considering that it is well known that modal coupling can be controlled, the combination of the physical attributes of the grating with the fibre's gradient index profile work together to optimise the grating wavelength spectrum. Of course, there will still be sensitivity to the launch conditions and illumination of the grating, but, in general, the FBG spectrum is rarely buried in the noise, and a recoverable spectrum is always possible. The results show that the best grating compromise corresponded to a grating with a 15 μm plane width, or less, across the fibre core. The multi-peak effect observed on that grating was very small; hence the optimum inscription parameters for gratings in the array correspond to 300-500 planes (˜0.65-1.1 mm) with 15 μm plane width, or less.

The inventor utilised the FBG array as a robust, 6-m sensing cord for direct mode shape capturing the motion of a free-free metal beam. This fibre length is not limited, and sensor arrays can readily operate over 60 m, compared to a few cm for FBGs in PMMA POF operating at 1550 nm.

Using the inscription parameters defined above, an FBG array was also inscribed, consisting of 6 FBGs separated physically by 8 cm and spectrally separated in the wavelength range of 1500-1600-nm, in a 6-metre length of multimode gradient index CYTOP fibre. The gratings were written “off line”, without active monitoring of the inscription process, showing the unique alignment tolerance of the method. The grating separation of 8 cm was selected for two reasons, firstly to match the experimental set-up for the vibrating beam, and, secondly as this distance matches or exceeds the maximum useable fibre length for PMMA POF operating at 1550 nm. A typical FBG reflection spectrum for the array consisting of six 4th-order FBGs inscribed using the novel technique, was interrogated with the I-MON 512, for an integrated capture time of 10 μs. The reflection responses of the six gratings were observed at 1529 nm, 1540 nm, 1548 nm, 1560 nm, 1571 nm, and 1580 nm with average full width at half maximum (FWHM) bandwidth of 1.39 nm. The length of each grating was about 0.65 mm with a period A about 2.2 μm; small variations in the grating period were used to set the operating wavelength of each FBG, and the overall inscription time was about 7 minutes per grating (including any alignment procedure). Each plane was inscribed in the centre of the core, using planes having 15 μm width.

An FBG array written in a single mode silica fibre (SMF28) was also inscribed using energies of about 100 nJ/pulse at 4-kHz repetition rate. The FBG array consisted of seven 4^{th} order FBGs inscribed using the novel technique. Each grating had about 2-mm length which consisted of 1000 planes of period A about 2 μm. The reflection responses of the seven gratings were observed at 1541 nm, 1548 nm, 1556 nm, 1563 nm, 1568 nm, 1569 nm and 1582 nm.

Reference is made to FIGS. 17A-17B representing examples of grating planes inscribed in CYTOP polymer optical fiber fabricated by using the teachings of the present invention where the depth of the grating plane is shown with respect to laser repetition rate for a fixed pulse energy, and with respect to pulse energy for a fixed repetition rate. Each material type can be calibrated to generate similar curves. The width and length are precision controlled through motion of the stages. This example demonstrates how the depth of the index change is controlled by repetition rate at a given laser energy, and with pulse energy for a given repetition rate. The figures indicate how a parameter space matrix can be developed for any transparent material. In all cases, the laser beam is focused to the center of the fiber core.

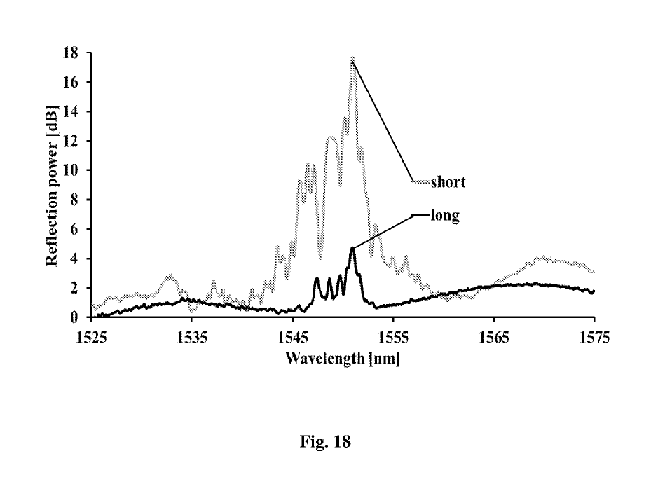

Reference is made to FIG. 18 representing a typical spectrum for a long FBG (10 mm) fabricated by using the teachings of the present invention in multimode POF, with the spectrum recovered from both the short side (a few cm from the FBG position in the fibre), to the long side, having traversed a physical fibre length in excess of 20 m, showing strong mode mixing.

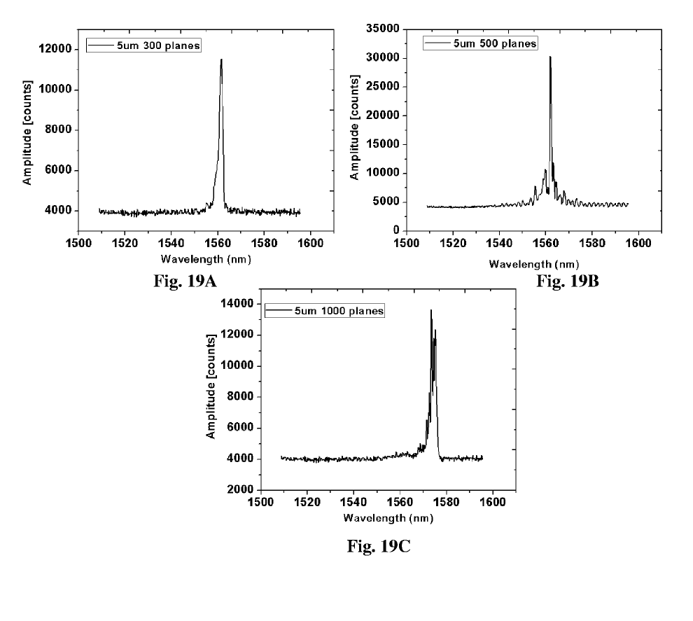

Reference is made to FIGS. 19A-19C representing improved spectra as the FBG is limited in spatial extent and length, with only a few modes being present and no signs of significant mode mixing for the 5 um and 300 plane grating (FIG. 19A). FIGS. 19B-19C present spectra of the FBG for the 5 um and 500 plane grating and the 5 um and 1000 plane grating respectively.

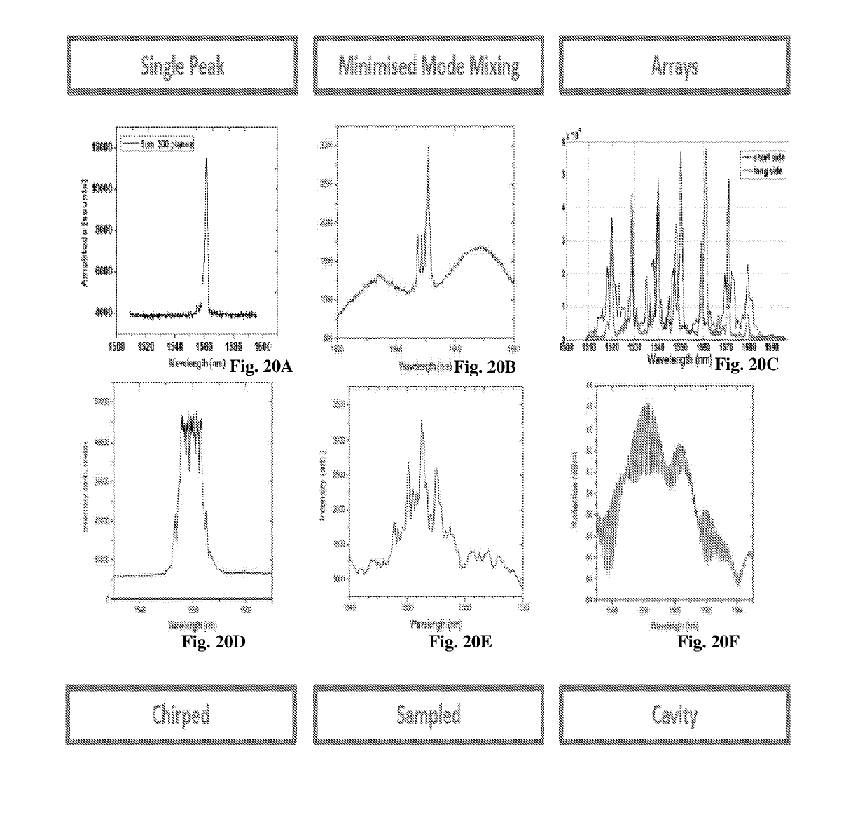

Reference is made to FIGS. 20A-20F representing different examples of different types of FBGs in multimode CYTOP polymer optical fibres fabricated by using the teachings of the present invention, based on controlled grating inscription, through accurate spatial extent and grating length control. In particular, FIG. 20A represents a spectra for a single peak FBG. FIG. 20B represents a spectra for a FBG having a minimised mode mixing, FIG. 20C represents a spectra for a FBG array, FIG. 20D represents a spectra for a chirped FBG, FIG. 20E represents a spectra for a sampled FBG and FIG. 20F represents a spectra for a FBG Fabry-Perot cavity. These figures demonstrate that the technique of the present invention has high flexibility and is capable of fabricating any type of FBG.

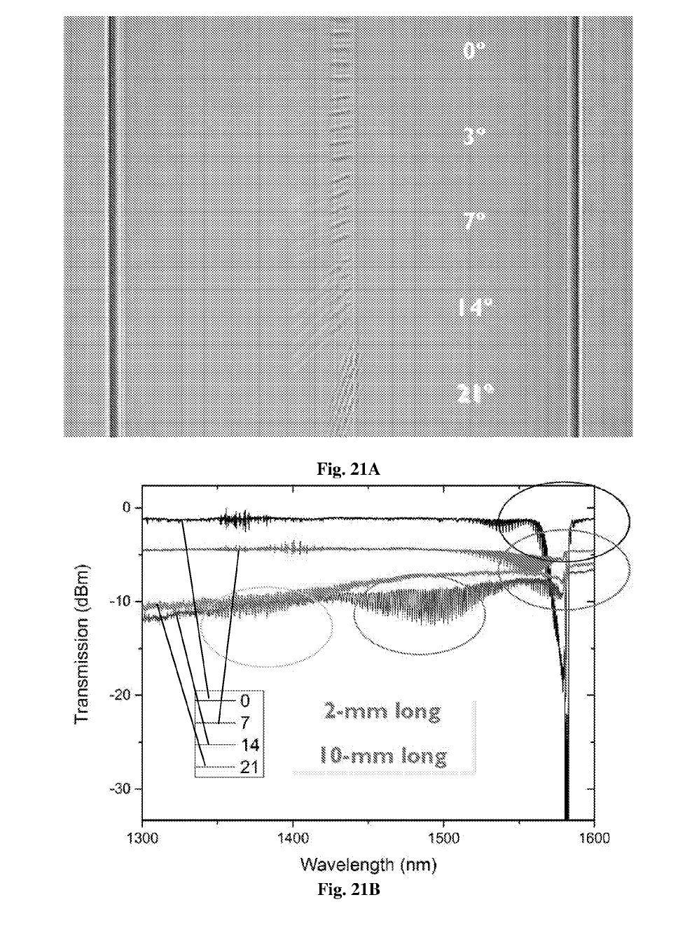

Reference is made to FIG. 21A showing a picture of a titled FBG fabricated by using the teachings of the present invention. As clearly shown in the figure, the angle can be user selected to reflect light into the cladding, and control of the spatial extent of the FBG can control the depth and size of the cladding modes as shown in FIG. 3B above. Reference is made to FIG. 21B which illustrates spectra, showing cladding modes of the FBG of FIG. 21A. As shown, the centre of mass of generating/excited cladding modes is also completely controlled by the user.

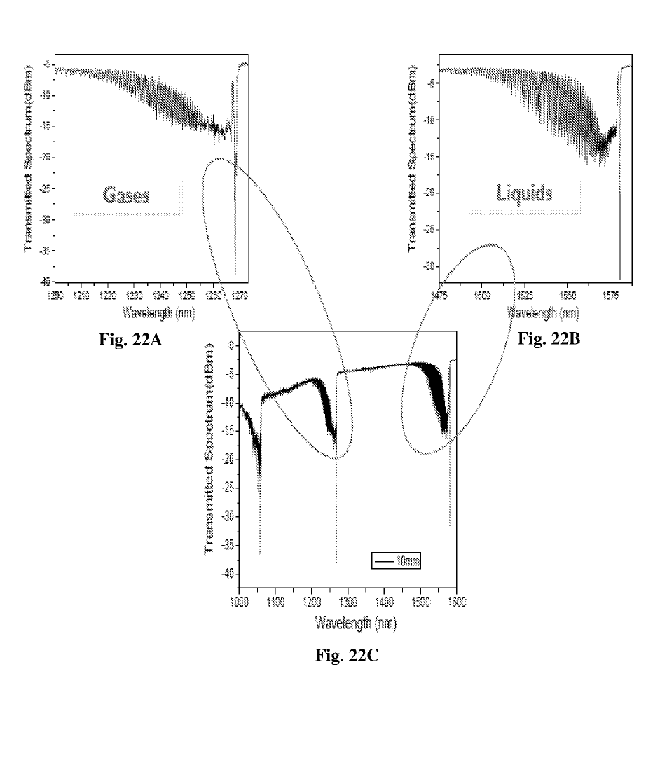

Reference is made to FIGS. 22A-22C showing spectra for higher order tilted FBGs showing the generation of cladding modes at multiple spectral locations, simultaneously, for sensing liquids and gases, according to the cladding mode wavelength position.

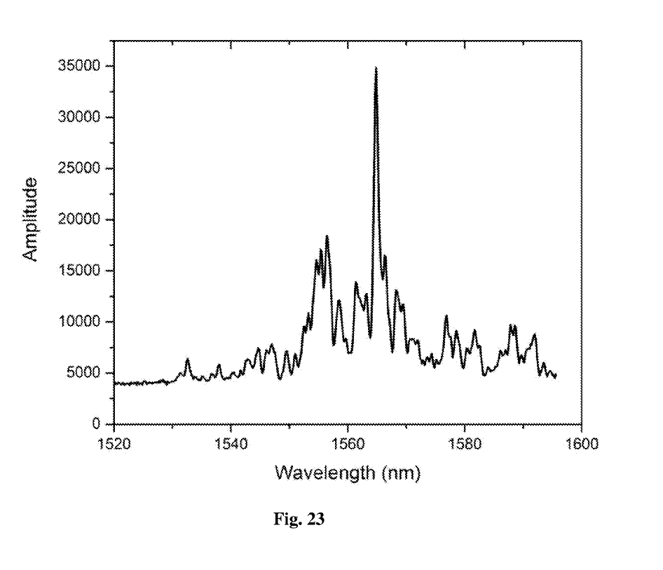

Reference is made to FIG. 23 representing a spectrum for a FBG created in silicon core optical fibre, using the inscription process of the present invention, based on modification of the silicon/glass interface—stress modulation. The silicon core is opaque to the laser inscription wavelength.

The novel technique of the present invention was thus implemented in such a way as to eliminate the typical multi-peak reflection and transmission spectra observed for FBGs inscribed in multimode fibres, and have minimised excitation to the lower order modes, producing, instead, single peak spectra. The modelling results match the measured FBG spectra, in particular 5μm and 15um width planes in terms of resonance wavelength, mode excitation and profile of the grating, but have deviations for the profile of the 30 μm plane width FBGs. A multiple, single-peak, FBG array was demonstrated in gradient index multimode CYTOP optical polymer fibre. The array was used to measure the vibration response of a free-free metal beam that was excited at its first resonance frequency six meters away from the launching point of the polymer fibre. The response of the polymer sensor array was compared with that of a silica FBG sensor array, and showed significant improvements in sensitivity, up to 6-times greater. The inventors have shown that a polymer optical fibre can perform very well in comparison with silica fibres. Hence, FBG sensor arrays can be realized in multimode polymer optical fibres, with the longest fibre length recorded for a multiple FBG array in POF sensors. The approach of the present invention is exceptionally flexible, allowing for user selectable Bragg wavelengths, controlled grating strength and spectral profile. It provides a novel and practical way of sensing with POF that has yet to he realised using other POF types.

1. A method for inscription of periodic patterns comprising the following steps:
(a) receiving a plurality of femtosecond laser pulsed beams, each beam having a certain pulse duration, flux, focal spot size, profile and energy at a certain wavelength of operation;
(b) controlling at least one of said pulse duration, flux, focal spot size, focal spot shape, profile and energy of the plurality of laser pulsed beams;
(c) directing the plurality of laser pulsed beams onto a certain region of a substrate having an optical axis to thereby selectively induce at least one of local index change, microvoids and stress-modulated region at a point of interaction between each beam and said certain region;
(d) controllably displacing said substrate along its optical axis to create said periodic patterns on a first plane of inscription along the optical axis; and
(e) creating spaced-apart planes across the substrate having a controlled index profile at least in two dimensions.

2. The method of claim 1, wherein said controlling of said laser pulsed beam comprises at least one of spatially modulating said laser pulsed beam, scanning said laser beam transversely across said substrate, perpendicularly to said optical axis; and creating at least one of a local index change, microvoids and stress-induced region at a boundary between two different materials in the substrate.

3. The method of claim 2, wherein said spatially modulating of said laser pulsed beam comprises at least one of scaling said beam by using an optical arrangement, and shaping the beam by using a spatial beam shaper.

4. The method of claim 2, wherein said scanning is repeated on the same region to thereby control a level of refractive index change.

5. The method of any one of claims 1 to 4, comprising irradiating said certain region wherein the irradiation is performed at a controlled speed of inscription.

6. The method of claim 5, comprising varying said speed of inscription independently for each plane of inscription to thereby modify said index profile and/or create a grating profile and/or produce higher order gratings.

7. The method of any one of claims 1 to 6, wherein said plane of inscription comprises a plane embedded inside the substrate.

8. The method of any one of claims 1 to 7, further comprising controllably displacing said substrate across its optical axis to create said periodic patterns on another plane of inscription spaced part from said first plane of inscription wherein said steps (a)-(e) are repeated at a certain period, wherein each grating plane is created individually, to thereby generate a grating structure.

9. The method of any one of claims 1 to 8, wherein said controllably displacing said substrate across its optical axis comprises controlling a line spacing between spaced-art planes with a linear or non-linear increment.

10. The method of any one of claims 1 to 9, wherein said controlling said pulse duration and energy comprises controlling at least one of width, depth and length of the periodic patterns across the substrate for each plane individually to thereby control a shape of a 3D index profile.

11. The method of claim 10, comprising creating non-symmetric planes in depth and width to create local birefringence.

12. The method of any one of claims 2 to 11, wherein said spatially modulating said laser pulsed beam comprises using at least one of a spatial light modulator, an optical arrangement with a variable focus, and an arrangement of focusing lenses.

13. The method of any one of claims 1 to 12, further comprising controlling a wavelength range of said femtosecond laser pulsed beams.

14. The method of any one of claims 1 to 13, wherein when said substrate comprises an optical fiber, and the certain region of the substrate comprises at least one of core only, cladding only, or core with cladding.

15. The method of any one of claims 1 to 14, comprising rotating said substrate at a certain angle relative to an optical axis of the substrate prior to the plane inscription to thereby control an angle of a plane of inscription relative to the optical axis creating tilted gratings.

16. The method of any one of claims 1 to 15, wherein the creating of spaced-apart planes across the substrate comprises controlling a length of said plane, thereby controlling the strength of reflection from each of the planes.

17. The method of any one of claims 1 to 16, wherein said controlling of said energy of the plurality of laser pulsed beams comprises varying said energy prior to inscription of each plane to control a birefringence of each plane and/or to control loss at the location of each plane.

18. A system for inscription of periodic patterns on a substrate having an optical axis; said system comprising:
a first beam directing module for directing a plurality of laser pulsed beams onto a certain region of the substrate to thereby selectively induce a local index change, microvoids and/or stress-modulated region at a point of interaction between each beam and said certain region, creating a controlled index profile on a plane of inscription at least in two dimensions;
a motion control module for displacing said substrate at least along its optical axis,
a control unit being connected to said motion control module and a laser for controlling at least one of pulse duration, flux, focus, profile and energy and a controlled speed of inscription to thereby provide an index profile on said plane of inscription at least in two dimensions.

19. The system of claim 18, further comprising a beam shaping element for spatially modulating the laser pulsed beam, wherein said beam shaping element comprises at least one of an optical arrangement with a variable focus, an arrangement of focusing lenses, slit element and a spatial light modulator.

20. The system of claim 19, further comprising a second beam directing module for directing said femtosecond pulsed laser beam towards said beam shaping element, wherein said beam directing module directs said femtosecond pulsed laser beam from said beam shaping element towards said certain region of said substrate.

21. The system of any one of claims 18 to 20, comprising a laser for generating a plurality of femtosecond pulsed laser beams having said certain pulse duration, flux, focal size spot, profile and energy at a certain wavelength of operation.

22. The system of any one of claims 18 to 21, wherein control unit controls wavelength range of operation of said laser.

23. The system of any one of claims 18 to 22, wherein said motion control module is configured for rotating said substrate.
